(19) United States
(12) Patent Application Publication
(10) Pub. No.: US 2002/0153487 A1
(43) Pub. Date: Oct. 24, 2002

(54) Room temperature quantum well infrared detector

(76) Inventor: Hui Chun Liu, Orleans (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 09/836,464

(22) Filed: Apr. 18, 2001

(51) Int. Cl. G01J 5/20

(52) U.S. Cl. 250/338.4; 257/21

(57) ABSTRACT

An infrared photodetector for high absorption efficiency at room or near room temperature is disclosed. The invention teaches a special design of quantum wells to obtain the desired performance. A quantum well infrared photodetector having a multi-quantum well structure for providing high absorption at room temperature and providing substantial dark current at room temperature is disclosed. The device also has contacts for receiving current from the multi-quantum well structure.

### FIELD OF THE INVENTION

This invention relates to optical and infrared detection devices and particularly to infrared photodetectors with high efficiency and operating at or near room temperatures.

### BACKGROUND OF THE INVENTION

Objects emit infrared radiation according to their temperature. An object at room temperature (i.e., 300 degree. K.), for example, emits infrared radiation that has a peak at around 10 μm. Even in complete darkness, i.e., in the absence of visible optical wavelengths, the infrared radiation emitted from the object can be detected. That detected radiation can be processed with an infrared-radiation detector to generate an image.

Infrared radiation detectors operating in the range of 3-14 μm have been used in night vision, navigation, flight control, weather monitoring, security, surveillance, and chemical detection. The earth's atmosphere is transparent to 8-12 μm radiation, and infrared-radiation detectors operating in this range are thus used in telescopes, communication systems, and in defense. IR scanner data has also been used to map sulfur dioxide fumes from quiescent volcanoes.

The early IR detectors were intrinsic detectors. An intrinsic photodetector takes advantage of optical radiation's capability of exciting a photocarrier, e.g., an electron. Such a photo-excited electron or “photoelectron” is promoted across the band gap from the valence band to the conduction band and collected. The collection of these photoelectrons produces a flow of electrons, which is detected as a current.

An intrinsic photodetector requires that an incoming photon from the radiation to be sensed is sufficiently energetic to promote an electron from the valence band to the conduction band. Hence, the energy of the photon =hν needs to be higher than the band gap E_{g} of the photosensitive material.

Quantum well detectors are known to support increased sensitivity. Quantum well photodetectors can be used to form a quantum well infrared photodetector (QWIP) that is sensitive to 3-25 μm infrared radiation. A quantum well is formed by packaging a relatively thin layer of a first semiconductor (typically GaAs) between adjacent layers of a second semiconductor (typically AlₓGa₁₋ₓAs). These semiconductor materials have a gap of inherent energies, “a band gap”, between them. The materials are used to form an energy “well” in the semiconductor. That well can be populated by electrons. The electrons are promoted by photons within the incoming radiation. The electrons are promoted by the photon from a ground state within the well to an excited state.

Spectral response of detectors has been adjusted by controlling the band gap. However, detection of long wavelength radiation, such as infrared radiation, requires a small band gap; e.g., around 100 meV. These low band gap materials are typically characterized by weak bonding and low melting points.

To overcome problems associated with weak bonding and low melting point, multi-quantum well structures (MQW) made of large band gap semiconductors were proposed. Positions of the energy levels in an MQW structure are primarily determined by the well height and width. For example, the energy level separation is increased as the thickness of the GaAs layer is decreased. The well's height also depends on the band gap of the AlₓGa₁₋ₓAs layer and the relative proportions of Al and Ga (“x”) in the AlₓGa₁₋ₓAs. The intersubband energy, i.e., the energy between the ground state E₁ and the first excited state, defines many of the essential characteristics of the quantum well.

Quantum well infrared photodetectors operate based on photoexcitation of an electron between ground and a first excited state in the quantum well. The basic operation of a single well is well known in the art.

An intrinsic infrared photodetector, as described above, increases the energy of an electron using one (or many) photons, and detects the resultant photoelectrons. The photon needs to be sufficiently energetic to increase the energy of the electron sufficiently to promote the electron from a valence band to a conduction band. This has is often termed interband operation, signifying the electron's promotion from one band to another band.

The QWIP is more accurately termed an intersubband system promoting electrons between subbands. Intersubband transitions operate between confined energy states, i.e., quantum wells associated with either the conduction band or valence band in the quantum well. Different kinds of intersubband transitions exist. A bound-to-bound transition is formed when both the ground state and the excited state of the excited electrons are bound within a quantum well.

In a multi-quantum well system, quantum wells generate photocurrent following intersubband absorption between two bound energy levels. A bound-to-bound intersubband absorption requires the infrared wavelengths to excite an electron from the ground state to a bound excited state within the well. The electron then tunnels through the edge of the well via quantum tunneling, to an unbound and continuous level above the well level, “the continuum level.” The bias on the well excites a flow of electrons through the continuum. This flow of electrons is detected as photocurrent.

The sensitivity of the detector is a function of efficiency of the photocurrent detection, i.e., the amount of detected photocurrent sensitivity is degraded by noise in the detector. This has provided a unique challenge to enhancing detector efficiency.

Dark current is a source of noise in QWIPs. Dark current is, as the name implies, current that flows in the dark, i.e., even when radiation to be detected is not reaching the QWIP. The dark current in a QWIP originates from three main mechanisms, quantum mechanical tunneling, thermally assisted tunneling and thermionic emissions.

Quantum mechanical tunneling from well to well through the barriers, also called sequential tunneling, occurs independent of temperature. This occurs to a very small extent, and dominates the dark current at very low temperatures.

Thermally assisted tunneling is based on thermally excited quantum tunneling through the tip of the barrier into the continuum. At medium temperatures, e.g., around 45° K. for an 8-9 μm detector, thermally assisted tunneling governs the dark current.

At the more usual high temperatures, greater than 45° K., classical thermionic emissions dominate the dark current. A thermionic emission occurs when the electrons are promoted by thermionic processes without an incoming photon.

All prior art teachings address dark current as a problem in QWIP devices. It is considered highly desirable to reduce the dark current to make a more sensitive detector, i.e., a detector with higher signal to noise ratio. However, it is also desirable that the detector produce as much photocurrent as possible.

The basic idea of using intraband or intersubband transition for infrared detection was disclosed in U.S. Pat. Nos. 4,205,331 by Esaki et al. and 4,873,555 by Coon et al. Embodiments of a quantum well infrared photodetector (QWIP) using intraband or intersubband transitions were disclosed in U.S. Pat. Nos. 4,894,526 and 5,023,685 both by Bethea et al. The design of a multicolor QWIP was taught in U.S. Pat. No. 5,646,421 by Liu. Mainly, these devices are intended for infrared thermal imaging where small temperature differences are detected. These prior-art devices are designed for operation at very low temperatures and are for detecting weak signals; each needs to be cryogenically cooled (<150 K) for optimal operation.

In related U.S. Pat. No. 5,567,955 in the name of Liu is described an integrated QWIP with light emission diode for use in imaging applications. Once again, the QWIP is for use in low temperature environments—typically cryogenically cooled environments.

Thermal imaging using focal plane arrays (FPAs) is the main existing application of QWIPs fabricated into array devices. For this weak signal case, the device parameters are chosen to achieve the highest possible sensitivity and background limited infrared performance (BLIP) temperature. The design principals for this existing application are reasonably established.

However, two factors—low dark current and high quantum efficiency—increase the signal-to-noise ratio of the photocurrent generated by the quantum well.

In order to overcome these and other limitations of the prior art, it is an object of the invention to provide a quantum well based infrared detector for use absent cryogenic cooling thereof.

It is a further object of the invention to provide a quantum well based infrared detector for use at or near room temperature.

It is also an object of the invention to provide a high efficiency infrared detector.

### SUMMARY OF THE INVENTION

In accordance with the invention there is further provided a quantum well infrared photodetector comprising: a plurality of doped quantum well layers forming a multi-quantum well structure for providing high absorption at temperatures other than low temperatures; and, contact layers for receiving current from the plurality of quantum well layers.

In accordance with the invention there is also provided a quantum well infrared photodetector comprising: a plurality of doped quantum well layers forming a multi-quantum well structure for providing high absorption and dark current at temperatures other than low temperatures; and, contact layers for receiving current from the plurality of quantum well layers.

In accordance with the invention there is further provided a quantum well infrared photodetector comprising: a plurality of quantum well layers formed of a first semiconductor material and doped forming a multi-quantum well structure for providing high absorption at temperatures other than low temperatures and substantial dark current; barriers between the quantum well layers formed of a second semiconductor material; and, contact layers comprising a third doped semiconductor.

Advantageously, a device according to the invention provides high frequency infrared detection at or near room temperature. For example, a device as described herein operates absent cryogenic cooling rendering the device less costly to operate and more suited to numerous applications where size, portability and so forth are significant.

Further advantageously, a device according to the invention provides high absorption of light having wavelengths within a target range of infrared wavelengths.

### BRIEF DESCRIPTION OF THE DRAWINGS

The invention will now be described with reference to the drawings in which:

FIG. 1 is a graphical representation of a double-pass 45-degree incidence transmission spectra at room temperature and with polarized light;

FIG. 2 is a graphical representation of spectral response curves at 80 K and 3 V wherein the full widths at half maximum are 260, 390, and 500 cm⁻¹ for 1E12, 1.5E12, and 2E12 cm⁻² doping samples, respectively;

FIG. 3 is a graphical representation of measured responsivity versus applied voltage under a CO2 laser (10.6 μm) illumination and at various temperatures for the 1.5E12 cm⁻² doping sample; and,

FIG. 4 is a graphical representation of detectivity at 10.6 μm for the 1.5E12 cm⁻² doping sample and for various temperatures.

### DESCRIPTION OF A PREFERRED EMBODIMENT OF THE INVENTION

QWIPs according to the techniques described in this specification can be used in near room temperature applications and within electronically cooled systems.

High frequency and high speed detectors may create new applications for QWIP sensors. Some exemplary applications include, environmental remote sensing of molecules and CO2 laser based or other long wavelength laser based communication, as well as laboratory use. A distinctive advantage of QWIP devices over standard detectors made of HgCdTe is their high intrinsic speed. This is related to the inherent short carrier lifetime (˜5 ps). For these applications, there is commonly a strong signal or a powerful local oscillator, in most cases employing lasers. Under such circumstances, a high dark current is tolerable, and a high absorption and high operating temperature is desirable. The sought after features for these applications relate to speed of the detector and operating conditions. Operating conditions such as operating temperature range affect portability, installation and maintenance, cost, power consumption and so forth. As such, operating conditions are a significant concern in selection of a detector.

Because of dark current present in high temperature QWIP devices, a primary design goal is to achieve high absorption. Starting from a standard QWIP structure, the absorption was improved by doping the wells more heavily and employing more wells. Three QWIP wafers were grown in a molecular beam epitaxy system. The main difference between the samples was doping density within each well. The period of the 100-repeat multiple quantum well structure of a GaAs well and AlGaAs barriers. The GaAs well center region was doped with Si to give an equivalent two-dimensional (2D) density of 1E12, 1.5E12, and 2E12 cm⁻², respectively. The well width were 6.6, 6.6, and 5.9 nm, the barrier width was 25.0, 25.0, and 24.0 nm, and the Al fraction was 0.200, 0.192, and 0.197, respectively, for the three samples. The top and bottom GaAs contact layers were 400 and 800 nm thick, doped with Si to 2E18 cm^{-3.}

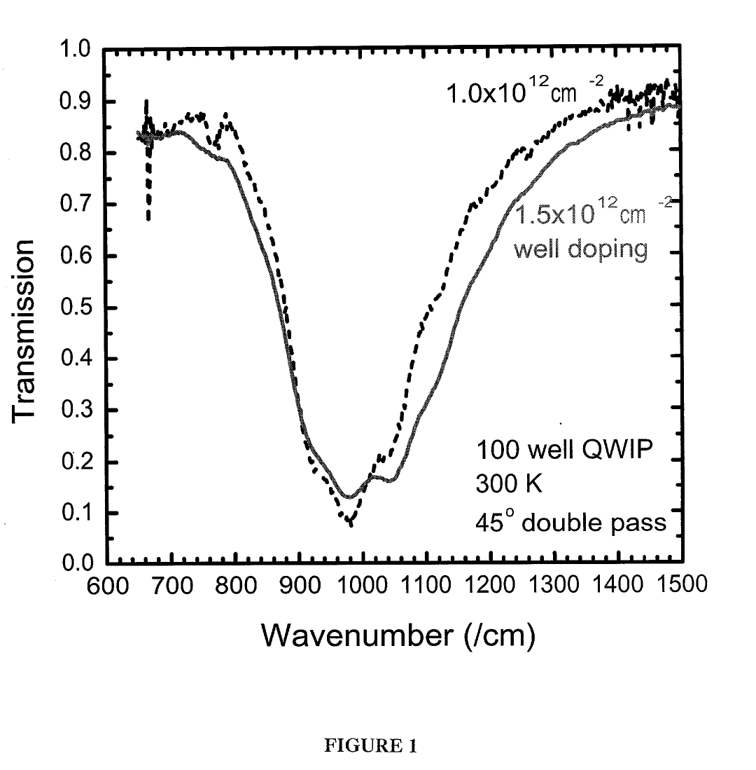

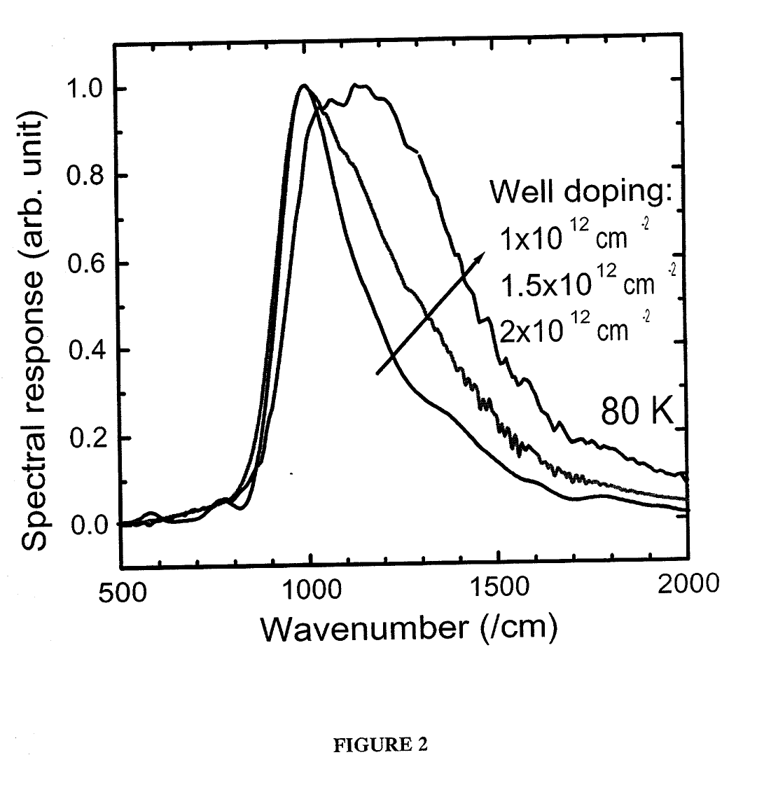

For high speed and high frequency applications, an array is not usually required and the 45-degree edge-facet geometry is a practical one. At 45-degree incidence and for polarized light, the absorption per quantum well per pass is about 0.54% per well for a standard 10-μm QWIP with 5E11 cm⁻² doping. For a doping density of 1.5E12 cm⁻², the one-well/one-pass absorption is expected to be η₁˜1.6%. If a 90% QWIP absorption is desired, the number of wells needed is determined by: exp(−2Nη₁)=10%, which gives N=72. The factor of 2 in the exponential accounts for the double passes in a 45-degree facet detector geometry. For a single pass geometry, a different number of wells results. N=100 was chosen in order to ensure high absorption. FIG. 1 shows the measured double-pass polarized 45-degree incident transmission spectra for samples with 1E12 and 1.5E12 cm⁻² doping densities, respectively. A high absorption was indeed achieved. The QWIPs were designed to cover the 10.3 and 10.6 μm branches of the CO2 laser. Of course, QWIPs could also be designed to cover other ranges of wavelengths. FIG. 2 shows the spectral response curves for the three samples.

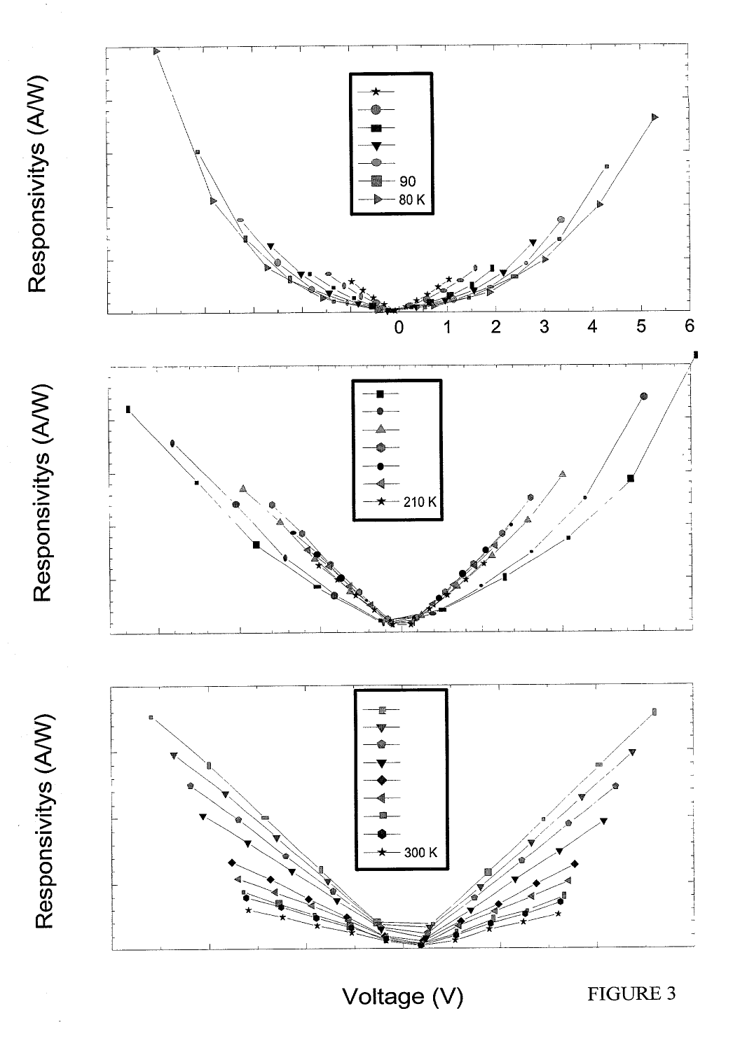

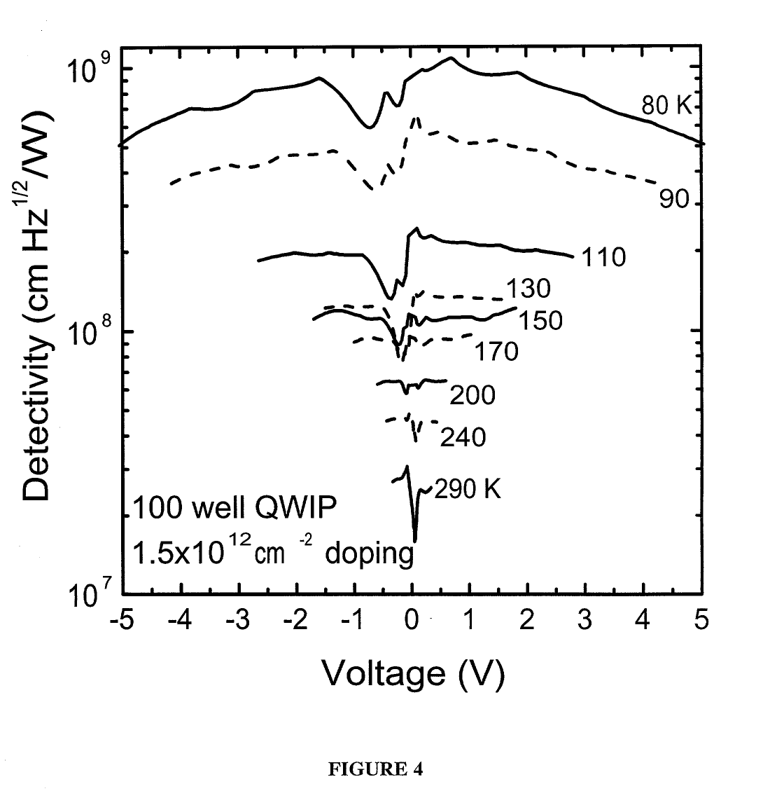

Further testing was performed to show that the design of the QWIPs was compatible with room and near room temperature operation. To maximize detector limited detectivity, the well doping density is such that the Fermi energy is E₁₌2k_{B}T, where T is the desired operating temperature. The 2D doping density is related to the Fermi energy by Nd=(m/π←²)E_{f}, where m is the well effective mass. For T=80 K, the required density is about 4E11 cm⁻² for GaAs wells. It is to be expected that the doping range of 1-2E12 cm⁻² is where QWIPs operate near room temperature albeit with a reduced sensitivity. Measured results at various temperatures using a CO2 laser tuned to 10.6 μm are shown in FIG. 3 for the 1.5E12 cm⁻² doping sample. It is clear that the device does work up to room temperature. Based on the measured dark current and responsivity and knowing the near ideal absorption (˜100%), the detectivity D* at 10.6 μm and for polarized light is calculated and plotted in FIG. 4 for various temperatures.

A 100-well QWIP with 1.5E12 cm⁻² doping per well achieved high absorption and operated at and near room temperature. This configuration is believed to be close to a best configuration for the standard QWIP design. Decreasing the doping may lead to a reduction in absorption; while increasing the doping seems to only result in a spectral broadening. At the present time, QWIPs are unique in having high speed/frequency capability and high absorption for the thermal infrared region. There are no competitive alternatives. For higher frequency applications (>30 GHz), it is possible to, for example, reduce the barrier width so that the inter-well tunneling becomes the main transport mechanism.

Of course, based on the present disclosure one of skill in the art would be able to use different parameters in order to meet specific design goals. For example, a device according to the invention can be designed to operate at different wavelengths or to operate at temperatures in excess of room temperature for some applications.

Other variations of material systems can be envisioned, for example, InGaAs well and AlGaAs barrier, InGaAs well and InP barrier, and others.

Also, valence band quantum wells can be used with the invention in place of the conducting band quantum wells described above.

Numerous other embodiments of the invention may be envisioned without departing from the spirit or scope of the invention.

What is claimed is:

1. A quantum well infrared photodetector comprising:
a plurality of doped quantum well layers forming a multi-quantum well structure for providing high absorption at temperatures other than low temperatures; and,
contact layers for receiving current from the plurality of quantum well layers.

2. A quantum well infrared photodetector according to claim 1 wherein the multi-quantum well structure is for providing high absorption at temperatures near room temperature.

3. A quantum well infrared photodetector according to claim 2 wherein the plurality of doped quantum well layers includes more than 10 quantum well layers.

4. A quantum well infrared photodetector according to claim 3 wherein the dopant concentration is selected to be sufficiently large for high absorption during near room temperature operation.

5. A quantum well infrared photodetector according to claim 4 wherein the doping density (Nd) is given by Nd=(m/π←²)(2k_{B}T), where m is the effective mass, ← is the Planck constant, k_{B} is the Boltzmann constant, and T is the desired operating in degrees K.

6. A quantum well infrared photodetector according to claim 5 wherein the well material is GaAs, the barrier material is Al GaAs, and the operating temperature is room temperature and Nd is in the range of 1-2E12 cm⁻².

7. A quantum well infrared photodetector according to claim 6 wherein the contact layers are formed of GaAs doped with Si to a concentration of 1E17 to 5E18 cm⁻³.

8. A quantum well infrared photodetector comprising:
a plurality of doped quantum well layers forming a multi-quantum well structure for providing high absorption and dark current at temperatures other than low temperatures; and,
contact layers for receiving current from the plurality of quantum well layers.

9. A quantum well infrared photodetector comprising:
a plurality of quantum well layers formed of a first semiconductor material and doped forming a multi-quantum well structure for providing high absorption at temperatures other than low temperatures and substantial dark current;
barriers between the quantum well layers formed of a second semiconductor material; and,
contact layers comprising a third doped semiconductor.

10. A quantum well infrared photodetector according to claim 9 wherein temperatures other than low temperatures include temperatures at or near room temperature.

11. A quantum well infrared photodetector according to claim 10 wherein the first semiconductor material is GaAs.

12. A quantum well infrared photodetector according to claim 11 wherein the dopant for doping the first semiconductor material is Si.

13. A quantum well infrared photodetector according to claim 12 wherein dopant concentration of the Si is approximately 1-2E12 cm⁻².

14. A quantum well infrared photodetector according to claim 13 wherein second semiconductor material is Al GaAs.

15. A quantum well infrared photodetector according to claim 14 wherein fraction of Al is from 10%-50%.

16. A quantum well infrared photodetector according to claim 15 wherein the third doped semiconductor material is GaAs doped with Si.

17. A quantum well infrared photodetector according to claim 16 wherein the third doped semiconductor material is doped with Si to a concentration of 1E17 to 5E18 cm⁻³.

18. A quantum well infrared photodetector according to claim 17 wherein the third doped semiconductor material of a thickness within a range of 0.1-2 μm.

19. A quantum well infrared photodetector according to claim 8 wherein the plurality of doped quantum well layers is designed for operation at frequencies above 1 GigaHz.

20. A quantum well infrared photodetector according to claim 19 wherein the plurality of doped quantum well layers is designed for operation at frequencies above 30 GigaHz.

21. A method of detecting infrared radiation comprising the steps of: detecting infrared radiation with a quantum well device absent cryogenic cooling; and, determining an intensity of the detected infrared radiation.

20. A method of detecting infrared radiation according to claim 19 wherein the step of determining comprises the step of:
filtering the dark current component of the detected signal to determine an intensity of the detected infrared radiation.

21. A method of detecting infrared radiation according to claim 19 wherein the step of detecting is performed at or near room temperature
